(19) United States
(12) Patent Application Publication
(10) Pub. No.: US 2005/0146591 A1
(43) Pub. Date: Jul. 7, 2005

(54) Recording apparatus

(75) Inventors: Hiroyuki Ogata, Fukuoka (JP); Masaharu Tanaka, Fukuoka (JP); Kenji Kanabo, Fukuoka (JP); Yutaka Miyazono, Fukuoka (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 11/028,303

(22) Filed: Jan. 4, 2005

(30) Foreign Application Priority Data
Jan. 7, 2004 (JP) 2004-002413
Jan. 21, 2004 (JP) 2004-012719

(51) Int. Cl. B41J 29/13

(52) U.S. Cl. 347/108

(57) ABSTRACT

A printer 1 comprises a casing 10 having an opening on the front side, and a front panel 31 covering the opening such that the opening can be opened and closed. Indication lights 61 to 66, an ink-shortage indication light 67, a sheet-kind selection button 55, and an ink-check button 56 are provided on the front panel 31. Each time a user presses the ink-check button 56, information about the kind of a recording sheet and information about ink shortage are alternately displayed on the indication lights 61 to 66.

### CROSS-REFERENCE TO RELATED APPLICATIONS

This non-provisional application claims priority under 35 U.S.C. §119(a) on Patent Applications No. 2004-2413 filed in Japan on Jan. 7, 2004 and No. 2004-12719 filed in Japan on Jan. 21, 2004, the entire contents of which are hereby incorporated by reference.

### BACKGROUND OF THE INVENTION

The present invention relates to a recording apparatus.

Conventionally, the recording apparatus is used as a printer for a personal computer, for example. However, many of the conventional recording apparatus need sufficient space for a set place. Therefore, the conventional recording apparatus can be set at only a place in which large space is provided in an upper part of a set surface in many cases. However, it is considered that the printer is used not only for the personal computer but also for various kinds of apparatuses such as a television, a video machine and the like in the future.

Thus, a thin-shaped printer is proposed so that it can be set in a place in which there is not enough space in the upper part such as a television rack, an audio rack and the like (refer to U.S. Pat. No. 6,296,407 and U.S. Pat. No. 6,340,256, for example). As shown in FIG. 28, the printer of this type comprises a thin-shaped casing 1000 having a configuration and dimension corresponding to audio equipment and the like. An input unit 1002 comprising operation buttons, a display unit 1003 comprising an indication light, a sheet feed cassette and a sheet discharge tray are arranged so that a user can operate them at the front of the casing 1000.

In addition, a relatively large opening 1005 is provided in a part of the front of the casing 1000 so that paper jammed inside the casing 1000 can be easily removed. A front cover 1004 is mounted on the casing 1000 so that it can open and close the opening 1005.

According to the conventional thin-shaped printer, the input unit 1002 and the display unit 1003 are arranged beside the front cover 1004. However, according to the thin-shaped printer in which the operations are performed from the front, it is necessary to provide the relatively large opening 1005 in order to facilitate handling of paper jam. Accordingly, it is necessary to provide the large front cover 1004. As a result, only small space is left beside the front cover 1004.

Thus, according to the conventional printer, the input unit 1002 and the display unit 1003 are collectively arranged in the small space beside the front cover 1004. However, since the operation buttons become small for the above reason, it is difficult for the user to operate them. In addition, since display space of the display unit 1003 becomes small, it is difficult for the user to view it.

### SUMMARY OF THE INVENTION

The present invention has been devised in view of the above problems and it is an object of the present invention to increase space for an input unit or a display unit in a recording apparatus which is operated from the front, and to improve easiness of operations or visibility of display.

A recording apparatus according to the present invention comprises an almost box-shaped casing having an opening at the front, a recording mechanism arranged in the casing, for performing a recording operation on a recording medium, and a front panel which comprises an input and display unit consisting of at least one of an input unit and a display unit on its front face and covers the opening of the casing such that the opening can be opened and closed.

According to the above recording apparatus, the input and display unit is provided on the front panel which opens and closes the opening of the casing. Therefore, it is not necessary to collectively arrange the input and display unit in small space beside the front panel. Therefore, while the opening of the casing can be large, the space for the input and display unit can be largely provided. As a result, convenience of operations and visibility of the display can be improved.

Another recording apparatus according to the present invention comprises an almost box-shaped casing having an opening at the front, a recording mechanism arranged in the casing, for performing a recording operation on a recording medium, a front cover which is provided on the front of the casing and covers at least the opening such that the opening can be opened and closed, detecting means for detecting opened and closed states of the front cover, control means for storing a recording operation command until the front cover is closed when it receives the recording operation command to be performed by the recording mechanism in a state where the front cover is opened, and directing the recording mechanism to perform the recording operation after the front cover is closed.

According to the above recording apparatus, when the recording operation command is input in the state where the front cover is opened, the recording operation is not carried out until the front cover is closed. Therefore, even if the user inserts the hand from the opening, the hand of the user and the recording mechanism do not bump against each other. In addition, paper jam caused by the recording operation in the state where the front cover is opened does not occur. Furthermore, the ink cartridge is not removed during the recording operation, so that air is prevented from being inhaled into an ink flow path. Meanwhile, the recording operation command is stored until the front cover is closed. Therefore, the user does not have to input the recording operation command again after the front cover is closed. As a result, the user can avoid the troublesome operation and convenience of the apparatus can be improved.

Still another recording apparatus according to the present invention comprises an almost box-shaped casing having an opening at the front, a recording mechanism arranged in the casing, for performing a recording operation on a recording medium, a front cover which is provided on the front of the casing and covers at least the opening such that the opening can be opened and closed, a discharge tray which is extendable or movable back and forth between a protruded state in which it is protruded forward from the casing and a housed state in which it is housed in the casing, and opening prohibiting means for prohibiting the front cover from being opened when the discharge tray is in the protruded state.

According to the above recording apparatus, when the discharge tray is in the protruded state, that is, when the discharge tray is protruded forward, the front cover is prohibited from being opened by the opening prohibiting means. Therefore, the front cover is prevented from being opened when the discharge tray is in the protruded state. As a result, the discharge tray and the front cover are surely prevented from bumping against each other.

Still another recording apparatus according to the present invention comprises an almost box-shaped casing having an opening at the front, a recording mechanism arranged in the casing, for performing a recording operation on a recording medium, a front cover which is provided on the front side of the casing and covers the opening such that the opening can be opened and closed, a discharge tray which is extendable or movable back and forth between a protruded state in which it is protruded forward from the casing and a housed state in which it is housed in the casing, and tray protrusion prohibiting means for prohibiting the discharge tray from being moved from the housed state to the protruded state when the front cover is opened.

According to the above recording apparatus, when the front cover is opened, the transition from the housed state to the protruded state of the discharge tray is prohibited by the tray protrusion prohibiting means. Therefore, the discharge tray is prevented from being pulled out forward when the front cover is opened. As a result, the discharge tray and the front cover are surely prevented from bumping against each other.

Other objects of the present invention will become more apparent from the detailed description of the present invention when taken in conjunction with the accompanying drawings for those in the art.

### BRIEF DESCRIPTION OF THE DRAWINGS

FIG. 1 is a perspective view showing a printer according to an embodiment 1.

FIG. 2 is a perspective view showing the printer in a state where a front panel is opened.

FIG. 3 is a perspective view showing the printer which is housed in a television rack.

FIG. 4 is a front view showing the printer.

FIG. 5 is a partially enlarged view showing an operation panel.

FIG. 6 is a perspective view showing an internal structure of the printer.

FIG. 7 is a sectional view showing an ink cartridge and a cartridge holder.

FIG. 8 is a view for explaining a variation of the operation panel.

FIG. 9 is a partially enlarged view showing the variation of the operation panel.

FIG. 10 is a front view showing a variation of the printer.

FIG. 11 is a front view showing a variation of the printer.

FIG. 12 is a front view showing a variation of the printer.

FIG. 13 is a front view showing a variation of the printer.

FIG. 14 is a front view showing a variation of the printer.

FIG. 15 is a perspective view showing a variation of the printer.

FIG. 16 is a perspective view showing a printer according to an embodiment 2.

FIG. 17 is a perspective view showing the printer in a state where a front cover is opened.

FIG. 18 is a perspective view showing the printer in a state where a sheet discharge tray is pulled out.

FIGS. 19A and 19B are perspective views showing sheet cassettes.

FIG. 20 is a conceptual view showing a setting example of the printer.

FIG. 21 is a block diagram showing a control unit.

FIG. 22 is a flowchart showing control of the printer.

FIG. 23 is a perspective view showing a printer according to a variation.

FIG. 24 is a perspective view showing a printer according to a variation.

FIG. 25 is a perspective view showing the printer according to the variation.

FIG. 26 is a sectional constitution view showing a variation of a locking mechanism.

FIG. 27 is a sectional constitution view showing the variation of the locking mechanism.

FIG. 28 is a perspective view showing a conventional printer.

### DETAILED DESCRIPTION OF THE INVENTION

### Embodiment 1

Hereinafter, preferred embodiments of the present invention will be described with reference to the accompanying drawings.

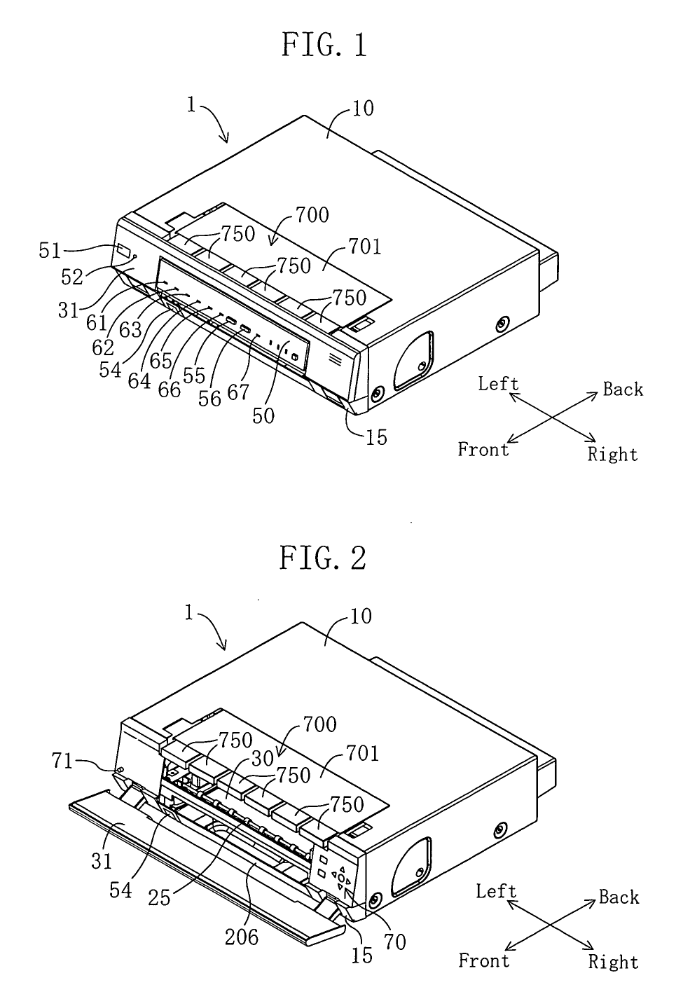

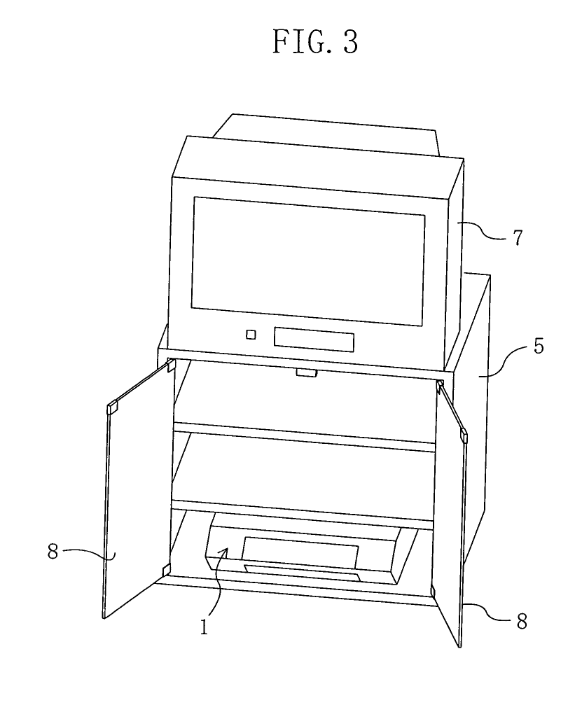

As shown in FIGS. 1 to 3, a recording apparatus according to the embodiment is a thin-shaped printer 1 which can be easily housed in a television rack 5, for example (refer to FIG. 3). According to the printer 1, an operation panel 50 is provided on its front face, and a sheet feed cassette and a sheet discharge tray are so constituted that they can be pulled out forward. A user can operate the printer 1 from the front while the printer 1 is housed in the rack 5.

A casing 10 is in the form of thin-shaped rectangular solid in which a length in the vertical direction is smaller than lengths in the right-and-left direction and in the back-and-forth direction. Here, the length in the vertical direction is not more than ¼ of the length in the right-and-left direction and not more than ⅓ of the length in the back-and-forth direction. As shown in FIG. 2, an opening 30 is formed on the front in the middle part in the right-and-left direction, through which a sheet is fed or discharged, an ink cartridge 750 is exchanged, or paper jam is handled.

An openable and closable front panel 31 which covers the opening 30 is provided at the front of the casing 10. Although a configuration and a dimension of the front panel 31 are not particularly limited, a length of the front panel 31 in the right-and-left direction is equal to the length of the casing 10 in the right-and-left direction in this embodiment. A length of the front panel 31 in the vertical direction is smaller than the length of the casing 10 in the vertical direction and it is about ¾ of the length of the casing 10 in the vertical direction. The front panel 31 covers the upper side of the front of the casing 10. In addition, a well-known opening and closing mechanism in the art such as a hinge mechanism can be used in an opening and closing mechanism of the front panel 31.

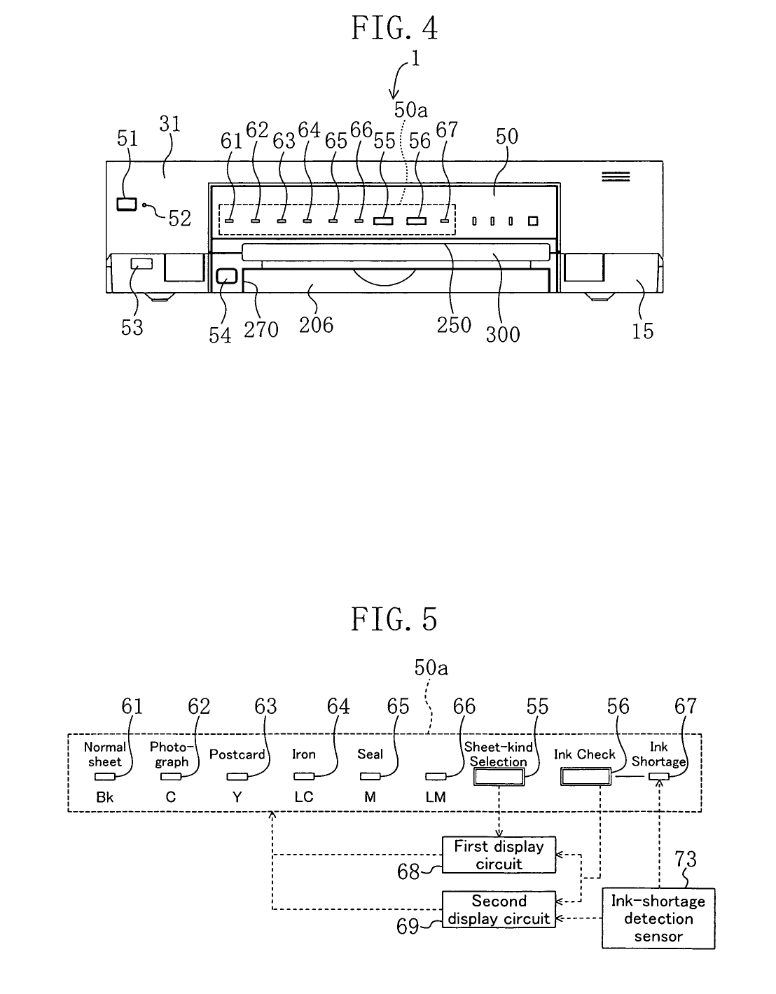

As shown in FIG. 4, a feed opening 270 is provided on a lower side of a front plate of the casing 10, to which a sheet feed cassette 206 is inserted. The sheet feed cassette 206 can be inserted or removed through the feed opening 270. A sheet discharge opening 250 is provided in the front plate 15 and the front panel 31 ranging from the upper side of the feed opening 270 in the front plate 15 to the lower side of the center part of the front panel 31. A sheet discharge tray 300 which can be pulled out forward is provided inside the sheet discharge opening 250. When the sheet is discharged, the sheet discharge tray 300 is projected forward and a discharged sheet is supported by the sheet discharge tray 300. In addition, the feed opening 270 and the sheet discharge opening 250 are laid to overlap each other in the vertical direction and both are provided in the center of the casing 10 in the right-and-left direction. Therefore, the user can feed and discharge the sheets in the center of the casing 10.

According to this embodiment, the sheets before recorded are put in the sheet feed cassette 206 once and the sheet is supplied from the feed opening 270 through the sheet feed cassette 206. However, it is needless to say that a mechanism in which the user directly feeds the sheet from the feed opening 270 may be provided. That is, the printer 1 may have a mechanism for manually feeding the sheet.

A push-button power supply switch 51 and an indication light 52 comprising an LED which turns on while the power supply is input are provided at a left end of the front panel 31. An operation panel 50 in which a plurality of switches and indication lights are arranged is provided in the center of the front panel 31. Reference numeral 53 designates a reception unit which receives a signal from a remote controller (not shown). Reference numeral 54 designates a button to eject the sheet feed cassette, and when the user presses the button 54, the sheet feed cassette 206 is discharged forward.

As shown in FIG. 5, in an operation display part 50a which is a part of the operation panel 50, first to sixth indication lights 61 to 66 and an indication light 67 to show ink shortage which comprise the LEDs, a sheet-kind selection button 55 and an ink-check button 56 are provided.

Characters which show the kind of the recording sheet are displayed on the upper sides of the first to fifth indication lights 61 to 65. More specifically, “normal sheet” is displayed on the upper side of the first indication light 61, “photograph” which shows a photograph recording sheet is displayed on the upper side of the second indication light 62, “postcard” which shows a postcard recording sheet is displayed on the upper side of the third indication light 63, “iron” which shows an iron-printing recording sheet is displayed on the upper side of the fourth indication light 64, and “seal” which shows a seal (sticker) recording sheet is displayed on the upper side of the fifth indication light 65. Meanwhile, characters showing the color whose ink is running out are displayed on the lower sides of the first to sixth indication lights 61 to 66. More specifically, “Bk” which shows black is displayed on the lower side of the first indication light 61, “C” which shows cyan is displayed on the lower side of the second indication light 62, “Y” which shows yellow is displayed on the lower side of the third indication light 63, “LC” which shows light cyan is displayed on the lower side of the fourth indication light 64, “M” which shows magenta is displayed on the lower side of the fifth indication light 65, and “LM” which shows light magenta is displayed on the lower side of the sixth indication light 66.

As shown in FIG. 5, a first display circuit 68 which displays the sheet kind in the sheet feed cassette 206, a second display circuit 69 which displays the color whose ink is running out, and a selection switch for switching the first display circuit 68 and the second display circuit 69 are provided for the first to sixth indication lights 61 to 66.

The sheet-kind selection button 55 is an input unit for inputting the sheet kind corresponding to the sheet kind put in the sheet feed cassette 206 by the user. According to this embodiment, a lighting part in the first to sixth indication lights 61 to 66 is moved to the right one by one each time the sheet-kind selection button 55 is pressed. In addition, when the sheet-kind selection button 55 is pressed after the sixth indication light 66 on the right most side turns on, the first indication light 61 turns on. Therefore, when the user wants to select the sheet kind, the user repeatedly presses the sheet-kind selection button 55 until the indication light corresponding to the kind of the sheet in the sheet feed cassette 206 turns on.

The ink-shortage indication light 67 automatically turns on when any ink is running out. An ink-shortage detection sensor 73 which detects shortage of ink is connected to the ink-shortage indication light 67. Thus, when the ink-shortage detection sensor 73 detects the shortage of any ink, it transmits a detection signal. The ink-shortage indication light 67 turns on when the detection signal is transmitted from the ink-shortage detection sensor 73. In addition, a well-known detection device can be used in the ink-shortage detection sensor 73.

The ink-check button 56 corresponds to the selection switch for switching the first display circuit 68 and the second display circuit 69. When the ink-check button 56 is pressed in a state where any color ink is running out, the indication light corresponding to that color ink turns on among the indication lights 61 to 66. That is, when the ink-check button 56 is pressed, any of the first to sixth indication lights 61 to 66 displays a state of the ink shortage instead of displaying the sheet kind. Therefore, the front panel 31 according to this embodiment can inform the user of the two kinds of information using the same indication lights.

As shown in FIG. 2, a so-called hidden key 70 which is covered with the front panel 31 is provided on the right side of the front plate 15 of the casing 10 (on the right side of the opening 30). Here, the hidden key 70 is constituted by push-button switches. In addition, a sensor 71 which detects an opening state or a closing state of the front panel 31.

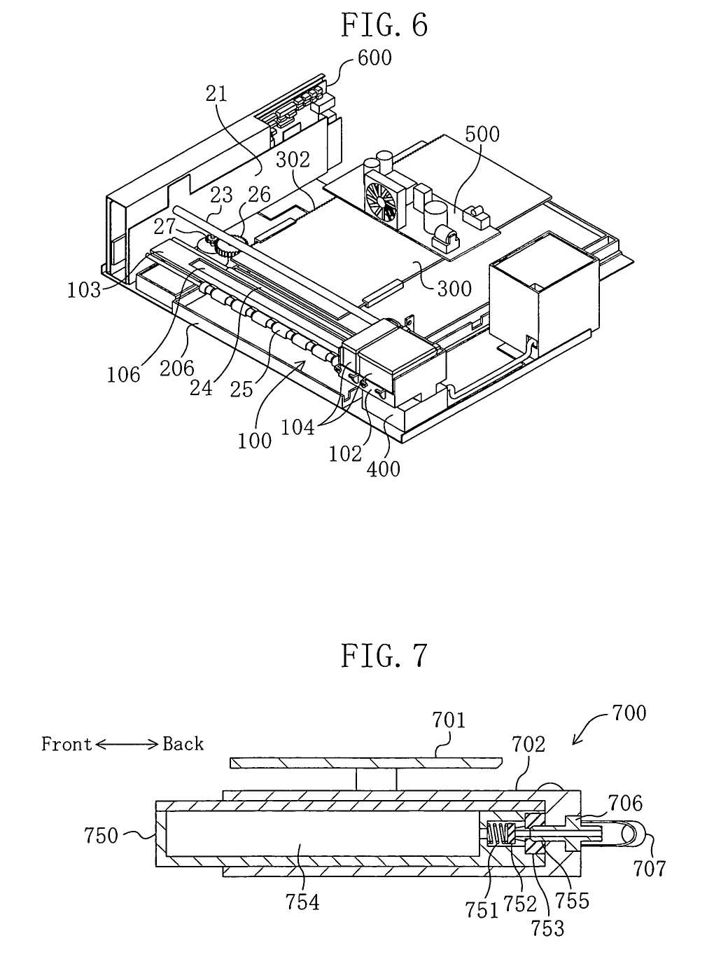

Then, an internal structure of the printer 1 will be briefly described. As shown in FIG. 6, a recording mechanism 100, the sheet feed cassette 206, the sheet discharge tray 300, a purge unit 400, a power supply board 500, and a control board 600 are provided in the casing 10.

The recording mechanism 100 comprises an ink-jet recording head (not shown), an ink tank 104, a carriage 102 mounting the recording head and the ink tank 104, and a platen 103 provided so as to be opposed to the recording head.

A side frame 21 which extends in the back-and-forth direction is provided on each of right and left sides in the casing 10 (a side frame on the right is not shown). A carriage axis 23 extending in the right-and-left direction is fixed to the front part of the side frame 21. The carriage 102 is moved in the right-and-left direction reciprocally along the carriage axis 23 by a driving mechanism (not shown). A dent is formed in the center of the platen 103 and a sponge 106 is provided in the dent.

The purge unit 400 is set on the right side of the carriage axis 23. While the ink is not jetted by the recording head, the carriage 102 stands by on the purge unit 400. At this time, a recording face of the recording head is covered with a cap (not shown). In this printer 1, a right end of the carriage axis 23 (that is, an upper part of the purge unit 400) is a home position for the recording head and the carriage 102. However, a left end of the carriage axis 23 may be the home position or both ends thereof may be the home positions for them.

The sheet feed cassette 206 is arranged at the bottom of the casing 10. The sheet discharge tray 300 is arranged at an upper part of the sheet feed cassette 206. A sawtooth (rack) 302 is formed on a left side end of the sheet discharge tray 300. The sawtooth 302 is connected to a gear motor 27 through a pinion 26, and the sheet discharge tray 300 is moved in the back-and-forth direction along with the rotation of the gear motor 27. However, the constitution of the sheet discharge tray 300 is not limited to the above. The sheet discharge tray 300 may be a tray which is pulled out by a manual operation of the user, for example.

The power supply board 500 is a printed circuit board on which a power supply circuit is formed. The control board 600 is a print circuited board on which a control unit of the printer 1 is provided. Although the first display circuit and the second display circuit may be provided on the front panel 31, they may be formed on this control board 600.

As shown in FIG. 2, a cartridge holder 700 is arranged at an upper part of the recording mechanism 100. The cartridge holder 700 is a holding member which detachably holds the plurality of ink cartridges 750. In this printer 1, six ink cartridges 750 containing black ink, cyan ink, yellow ink, light cyan ink, magenta ink and light magenta ink, respectively are mounted on the cartridge holder 700.

As shown in FIG. 7, the cartridge holder 700 comprises an upper plate 701 and a holder body 702. An opening to insert the ink cartridge 750 is formed in the holder body 702. An ink needle 706 which jets out the ink from the ink cartridge 750 is fixed to an inner part of the opening, that is, to an inner wall of the back side of the holder body 702. The ink needle 706 penetrates the holder body 702 and its tip end protrudes toward an inner part of the holder body 702. Meanwhile, its base part of the ink needle 706 is exposed outside the holder body 702. One end of a flexible ink tube 707 is mounted on the base part of the ink needle 706. The other end of the ink tube 707 is connected to the ink tank 104 mounted on the carriage 102. The ink of the ink cartridge 750 is supplied to the ink tank 104 through the ink tube 707 and then supplied to the recording head from the ink tank 104.

An ink chamber 754 containing the ink is provided in the ink cartridge 750 and an ink supply opening 755 is provided at one end (right end in FIG. 7) of the ink cartridge 750. A rubber lid 753 in which an opening is formed in the center is fit in the ink supply opening 755. A coil spring 751 and a valve 752 which is fixed to a tip end of the coil spring 751 are provided in the vicinity of the ink supply opening 755 in the ink cartridge 750.

While the ink cartridge 750 is not mounted on the cartridge holder 700, the valve 752 is forced toward the rubber lid 753 and the opening of the rubber lid 753 is closed by the valve 752. Meanwhile, as shown in FIG. 7, when the ink cartridge 750 is mounted on the cartridge holder 700, the ink needle 706 pushes the valve 752 forward against the force of the coil spring 751, so that the valve 752 is opened. Thus, the ink in the ink chamber 754 is jetted from the ink needle 706 and the ink tube 707.

During the recording operation by the printer 1, the recording sheet in the sheet feed cassette 206 is picked up by a pick-up roller (not shown) and the recording sheet is conveyed to the recording mechanism 100 by a conveyance roller 24 (refer to FIG. 6). Then, the recording head 101 jets out the ink, moving in the right-and-left direction along with the movement of the carriage 102 to perform a recording operation on the recording sheet on the platen 103. The recorded sheet is conveyed forward by a sheet discharge roller 25 and discharged to the front of the casing 10 through the discharge opening 250. The recorded sheet discharged from the discharge opening 250 is supported by the sheet discharge tray 300 which is protruded toward the front of the casing 10.

When at least one color of the ink is running out, the ink-shortage indication light 67 in the operation panel 50 turns on (refer to FIG. 5). The user can easily recognize the ink shortage when the indication light 67 turns on. Then, when the user presses the ink-check button 56, the indication lights 61 to 66 are changed over from a mode displaying the sheet kind to a mode displaying the ink shortage and the indication light corresponding to the color ink which is running out turns on among the indication lights 61 to 66. As a result, the user can recognize the color of the ink which is running out and then the ink cartridge 750 is exchanged smoothly.

An exchanging operation of the ink cartridge 750 and an operation for sheet-jam are performed after the front panel 31 is opened. That is, when the user performs the exchanging operation of the ink cartridge 750 or the operation for the sheet jam, the user opens the front panel 31 forward as shown in FIG. 2 and exposes the opening 30 at the front of the casing 10. Thus, the user can easily remove and insert the ink cartridge 750 through the opening 30. In addition, since the user can easily insert the hand in the casing 10, the user can easily handle the sheet jam.

As described above, according to this printer 1, the display unit comprising the indication light 52 and the indication lights 61 to 66, and the input unit comprising the power supply switch 51 and the sheet-kind selection button 55 are provided on the front panel 31 which can be freely opened and closed. Therefore, the display and the input units can be arranged at the front of the printer 1 over a large range regardless of the size of the opening 30 of the casing 10.

More specifically, as shown in FIG. 4, the indication light 52 showing an ON/OFF state of the power supply is provided at a left end of the front panel 31 and the indication lights 61 to 67 are provided in the center thereof. Thus, according to this printer 1, since the display units can be arranged so as to be spread, visibility of the display units can be improved. In addition, since the respective indication lights can be relatively large in size, the visibility can be improved also in this respect.

Furthermore, since the power supply switch 51 is provided at the left end of the front panel 31 and the sheet-kind selection button 55 and the ink-check button 56 are provided in the center thereof, the input units can be arrange so as to be spread, operability of the input units can be improved. In addition, since the respective operation buttons can be large in size, the operability can be improved also in this respect.

According to this printer 1, the indication lights 61 to 66 and the ink-shortage indication light 67 are provided on the operation panel 50 which is positioned in the center of the front panel 31. In addition, the sheet-kind selection button 55 and the ink-check button 56 are also provided on the operation panel 50. Thus, since these indication lights 61 to 67, the sheet-kind selection button 55 and the ink-check button 56 are arranged in the center of the front face of the printer 1, the user can easily see and operate them. Therefore, according to this printer 1, the visibility of the indication lights 61 to 67 can be improved and the operability of the sheet-kind selection button 55 and the ink-check button 56 can be improved. As a result, convenience for the user can be enhanced.

In addition, according to this printer 1, the two kinds of information can be selectively displayed on the respective indication lights 61 to 65 by the switching operation through the ink-check button 56. Therefore, the number of indication lights can be reduced, so that the printer 1 can be provided at a low cost. Furthermore, since the number of the indication lights is reduced, the indication lights can be arranged apart from each other. Furthermore, although the space for the indication lights is limited, since the number of them is reduced, the size of each indication light can be large. Thus, the visibility of the indication lights can be improved in this respect also.

In addition, although the two kinds of information can be displayed by the indication lights 61 to 65 in the above printer 1, it is needless to say that the information displayed by the indication lights is not limited to two kinds and three or more kinds of information can be displayed.

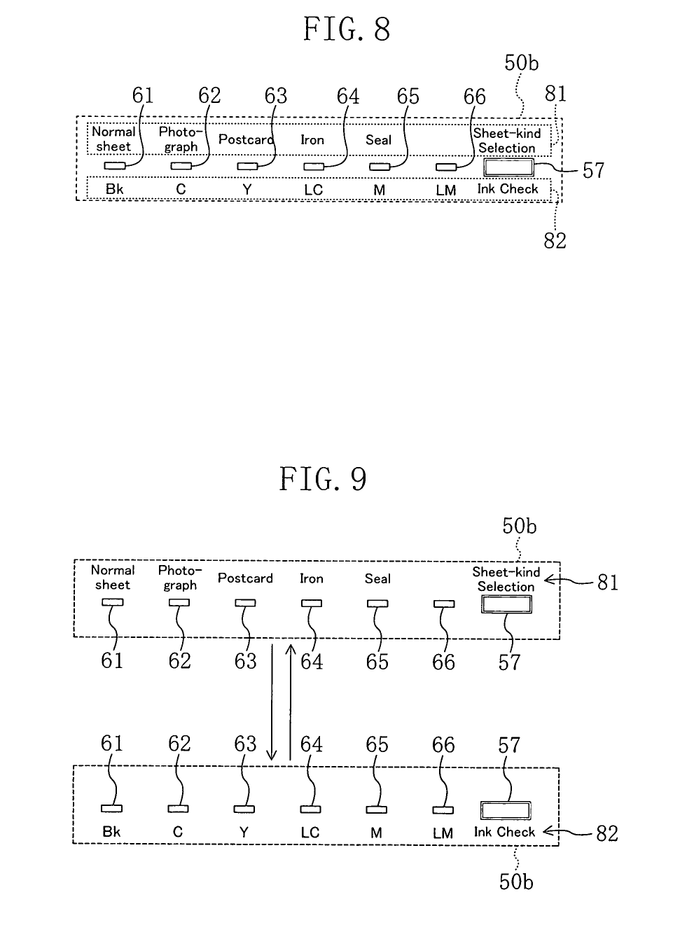

In addition, the operation panel 50 of the printer 1 is not limited to the above, it may have various kinds of configurations. Next, a variation of the operation panel 50 will be described with reference to FIGS. 8 and 9.

FIG. 8 shows an operation display part 50b which is a part of an operation panel 50. A display switch button 57 is arranged on the right side of a sixth indication light 66 in the operation display unit 50b. Characters “Sheet-kind Selection” are displayed on the upper side of the display switch button 57. Meanwhile, characters “Ink Check” are displayed on the lower side of the display switch button 57. Characters showing the kinds of the sheet displayed on the upper sides of the first to sixth indication lights 61 to 66 and the characters “Sheet-kind Selection” provide a sheet-kind display part 81, and characters showing the ink colors displayed on the lower sides of the first to sixth indication lights and the characters “Ink Check” provide an ink-information display part 82. A back light (not shown) is provided on the back side of each of the sheet-kind display part 81 and the ink-information display part 82. On this operation panel 50, the first display circuit and the second display circuit are changed over each time the display switch button 57 is pressed, and accordingly the back lights of the sheet-kind display part 81 and the ink-information display part 82 alternately turns on.

For example, as shown in an upper view of FIG. 9, in a state where the back light of the sheet-king display part 81 is on and the sheet kind is displayed on the upper side of the indication lights 61 to 65 (hereinafter, this state is referred to as the normal display state), when the display switch button 57 is pressed, as shown in a lower view of FIG. 9, the back light of the sheet-kind display part 81 turns off and the back light of the ink-information display part 82 turns on. In addition, the circuit connected to the indication lights 61 to 66 is switched from the first display circuit to the second display circuit. As a result, the ink-information display part 82 is displayed in the operation display part 50b and the indication light corresponding to the ink color which is running out turns on (hereinafter, this state is referred to as the ink-information display state).

Meanwhile, when the display switch button 57 is pressed in the ink-information display state, the back light of the ink-information display part 82 turns off and the back light of the sheet-kind display part 81 turns on. In addition, the circuit connected to the indication lights 61 to 66 is switched from the second display circuit to the first display circuit. As a result, as shown in the upper view of FIG. 9, the display state is switched from the ink-information display state to the normal display state, and the indication light corresponding to the kind of the recording sheet contained in the sheet feed cassette 206 turns on in the operation display part 50b.

As shown in FIG. 4, according to the printer 1 in the above embodiment, the operation panel 50 is arranged on the upper side of the sheet feed cassette 206 and the sheet discharge tray 300. However, the positional relation in the vertical direction between the operation panel 50, the sheet feed cassette 206 and the sheet discharge tray 300 is not limited to the above.

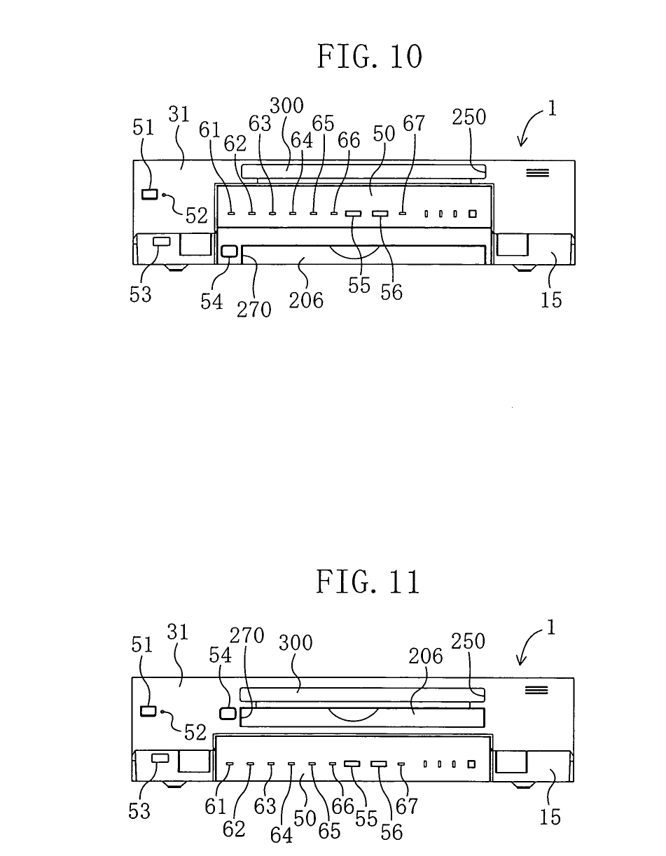

For example, as shown in FIG. 10, the operation panel 50 may be arranged between the sheet feed cassette 206 and the sheet discharge tray 300. Alternatively, as shown in FIG. 11, the operation panel 50 may be arranged on the lower side of the sheet feed cassette 206 and the sheet discharge tray 300.

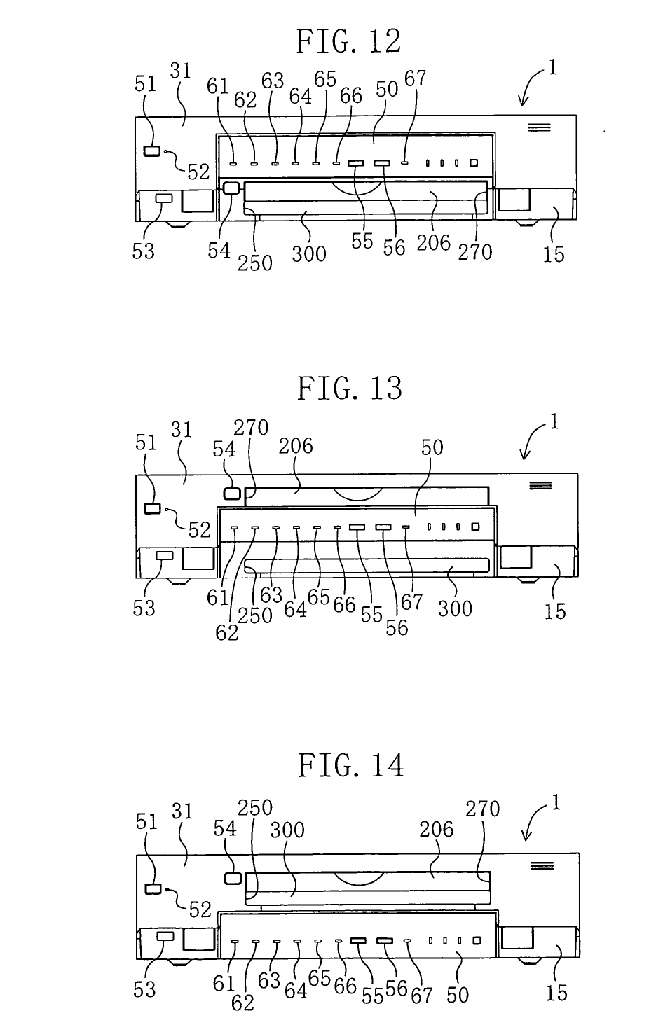

Furthermore, as shown in FIG. 12, the operation panel 50, the sheet feed cassette 206, and the sheet discharge tray 300 may be arranged downward in this order. Still further, as shown in FIG. 13, the sheet feed cassette 206, the operation panel 50, and the sheet discharge tray 300 may be arranged downward in this order. Still further, as shown in FIG. 14, the sheet feed cassette 206, the sheet discharge tray 300, and the operation panel 50 may be arranged downward in this order. In addition, the operation panel 50 is provided on the front panel 31 which can be opened and closed in any above variation.

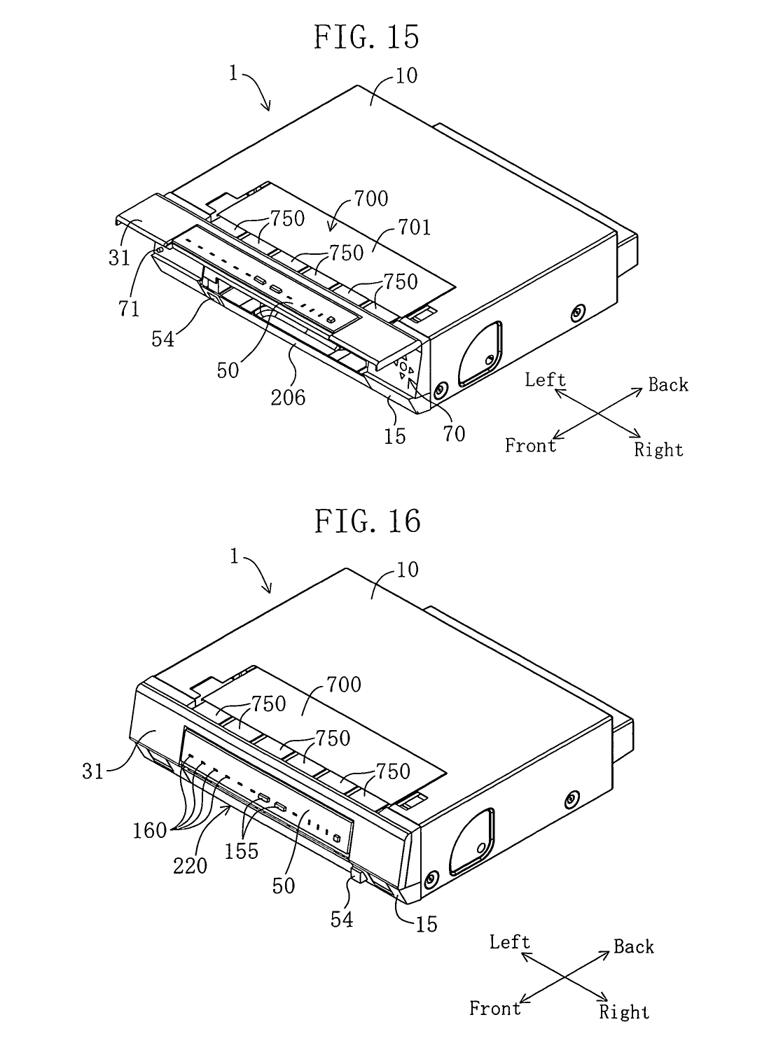

As shown in FIG. 2, according to the printer 1 in the above embodiment, the front panel 31 is opened downward. In other words, the front panel 31 is turned around its lower part. However, the opening and closing way of the front panel 31 is not limited to the above. For example, as shown in FIG. 15, the front panel 31 may be opened upward. That is, the front panel 31 may be turned around its upper part. In addition, although it is not shown, the front panel 31 may be opened sideways. Or the front panel 31 may be divided into two blocks and the two blocks may be opened outward.

### Embodiment 2

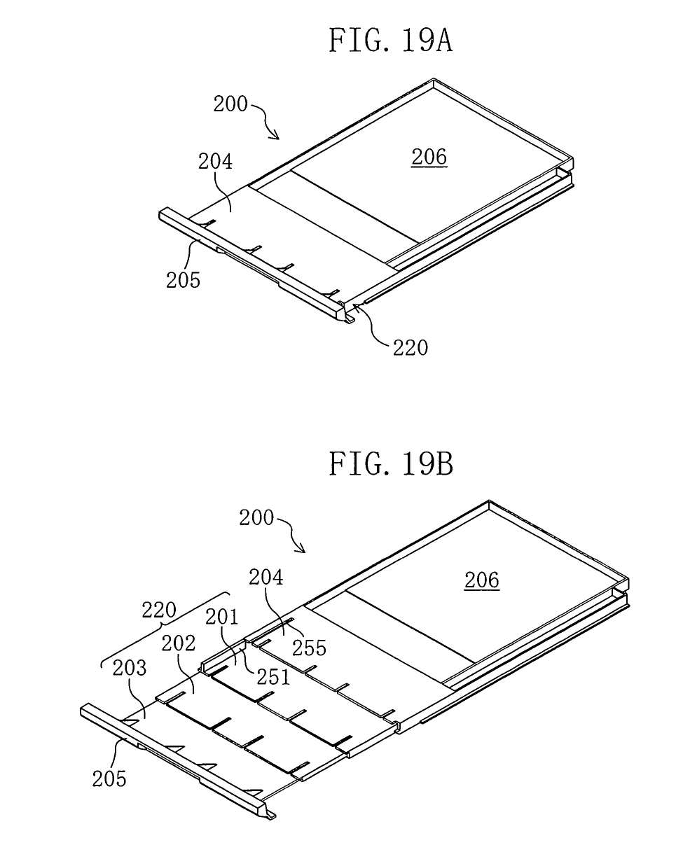

As shown in FIG. 16, a printer 1 according to an embodiment 2 is the same as that of the embodiment 1 in that it is the thin-shaped printer 1 which can be housed in a television rack 5 (refer to FIG. 3). The printer 1 of the embodiment 2 is different from that of the embodiment 1 in that a sheet feed cassette 206 containing recording sheets before recorded and a sheet discharge tray 220 which supports the recording sheets after recorded are integrally provided to constitute a sheet cassette 200 as shown in FIGS. 19A and 19B. Hereinafter, with respect to the printer 1 according to the embodiment 2, a description about the same constitution as that in the embodiment 1 is omitted and the different constitution from that in the embodiment 1 will be described.

An insert opening 273 is provided on the lower side of a front plate 15 of a casing 10. As shown in FIG. 18, the sheet cassette 200 can be inserted and removed through this insert opening 273. As described above, the sheet cassette 200 integrally comprises the sheet feed cassette 206 and the sheet discharge tray 220. The sheet discharge tray 220 is provided in front of the sheet feed cassette 206. (refer to FIGS. 19A and 19B).

The sheet discharge tray 220 is constituted by assembling a base tray 204, a first tray 201, a second tray 202 and a third tray 203 back and forth. These base tray 204, the first tray 201, the second tray 202 and the third tray 203 are assembled so as to slide in the back-and-forth direction. Thus, the sheet discharge tray 220 can be extended forward. A handle 205 is provided at a front end of the third tray 203.

A thin rib 251 which protrudes upward and is long in the back-and-forth direction is provided at a left end of the first tray 201. A groove 255 to which the rib 251 is inserted is provided at a left end of the base tray 204.

In addition, the sheet discharge tray 220 according to this embodiment can be extended forward. However, the constitution of the sheet discharge tray 220 is not limited to the above and another constitution may be employed for the sheet discharge tray 220. For example, the sheet discharge tray 220 may slide entirely back and forth.

As shown in FIG. 16, an operation panel 50 is provided on a front panel (front cover) 31. On the operation panel 50, a plurality of indication lights 160 each comprising an LED or another luminous body, and an operation push-button 155 are arranged. However, the constitution of the operation panel 50 is not limited to the above.

A cassette eject button 54 for the sheet cassette 200 is arranged in a lower right part of the front plate 15 of the casing 10. When the user presses the cassette eject button 54, the sheet cassette 200 is discharged forward.

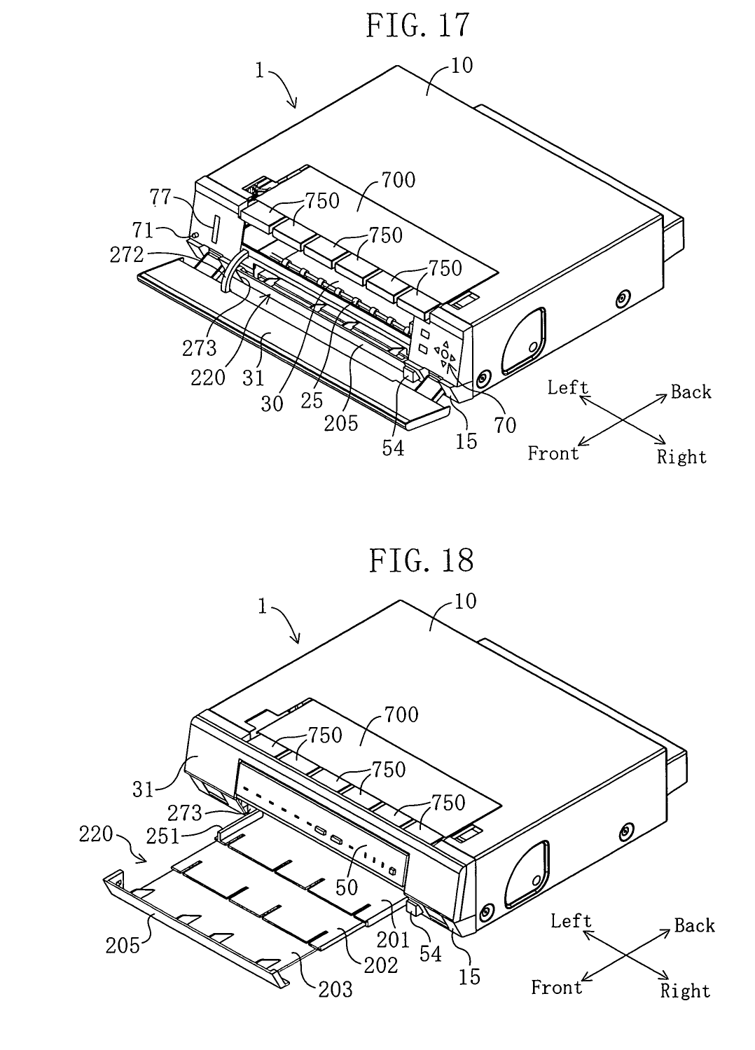

As shown in FIG. 17, a hidden key 70 is provided in a right end part of the front plate 15 of the casing 10, and an insert slot 77 to which a card recording medium is inserted is provided in a left end part of the front plate 15.

In addition, a sensor 71 for detecting opening and closing states of the front panel 31 is provided in the left part of the front plate 15. The sensor 71 comprises a push-button switch. When the front panel 31 is closed, the sensor 71 is in a pressed state. Meanwhile, when the front panel 31 is opened, the sensor 71 is in a protruded state. Therefore, the opening and closing states of the front panel 31 can be easily detected by the state of the sensor 71.

A tray-lock rib 272 which is in the form of approximate circular arc is fixed to a back face of the front panel 31. The rear side of the tray-lock rib 272 is inserted into the casing 10 such that it is freely protruded or withdrawn. That is, when the front panel 31 is opened, the tray-lock rib 272 is protruded forward, and when the front panel 31 is closed, it is withdrawn backward. The tray-lock rib 272 is arranged in a left part of the sheet discharge tray 220. In the state where the front panel 31 is opened, the tray-lock rib 272 and the sheet discharge tray 220 overlap each other in the back-and-forth direction. Therefore, in the state where the front panel 31 is opened, the sheet discharge tray 220 is prevented from moving forward by the tray-lock rib 272. Thus, the sheet discharge tray 220 is prohibited from being pulled out in the state where the front panel 31 is opened.

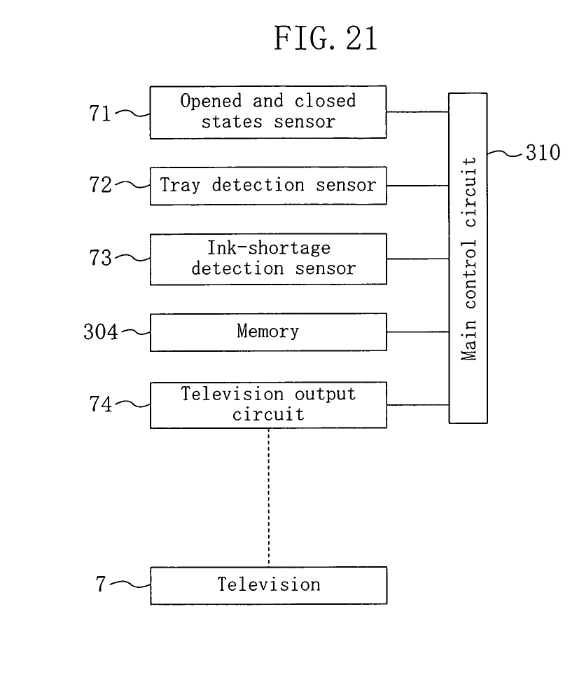

A tray detection sensor 72 (refer to FIG. 21) which detects whether the sheet discharge tray 220 is pulled out forward or not is provided inside the casing 10 although it is not shown. However, the constitution of the tray detection sensor is not limited to the above and the well-known constitution in the art can be employed. For example, a light-reflection type or a light-transmission type of optical sensor may be provided inside the casing 10 as the tray detection sensor 72 to detect the pulled-out state of the sheet discharge tray 220.

In addition, the state in which the sheet discharge tray 220 is housed (refer to FIG. 16) is referred to as the housed state, and the state in which the sheet discharge tray 220 is protruded (refer to FIG. 18) is referred to as the protruded state in the following description.

The internal structure of the printer 1 is almost the same as that in the embodiment 1 (refer to FIG. 6). That is, an inkjet recording mechanism 100, the sheet cassette 200, a purge unit 400, a power supply board 500, and a control board 600 are provided in the casing 10. However, since the sheet discharge tray 300 is manually pulled out in the printer 1 according to the embodiment 2, a rack 302, a pinion 26 and a gear motor 27 for moving the sheet discharge tray 300 are omitted.

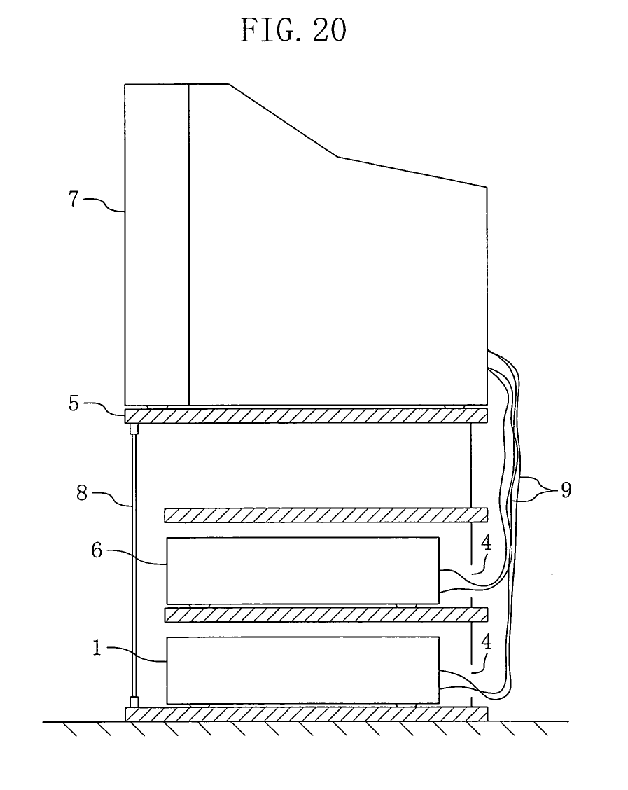

Next, a setting example of the printer 1 will be described with reference to FIG. 20. The printer 1 is housed in the television rack 5 together with a DVD recorder 6. A television 7 is set on the rack 5. A glass door 8 is provided at the front side of the rack 5. Openings 4 through which power cords or signal lines 9 pass are formed on the rear side of the rack 5. The printer 1 and the DVD recorder 6 are connected to the television 7 through the signal lines 9. However, the printer 1 may transmit a signal to the television 7 wirelessly.

As shown in FIG. 21, the control unit of the printer 1 comprises a main control circuit 310, a memory 304, and a television output circuit 74. The output circuit 74 displays information about the state and operation of the printer 1 on a screen. In addition, the output circuit 74 may notify the user of the information of the state and the operation of the printer 1 with audio through a speaker of the television 7 instead of the screen display or together with the screen display of the television 7.

The front panel sensor 71 and the tray detection sensor 72 are connected to the main control circuit 310 to transmit a detection signal to the main control circuit 310 all the time. In addition, an ink-shortage detection sensor 73 which is provided in a cartridge holder 700 to detect whether there is ink shortage in each ink cartridge 750 or not is connected to the main control circuit 310 also, so that its detection signal is transmitted to the main control circuit 310 all the time. Thus, the main control circuit 310 knows the opened and closed states of the front panel 31, the protruded and housed states of the sheet discharge tray 220, and the ink-shortage state of the ink cartridge 750 all the time.

Next, the control of the printer 1 will be described.

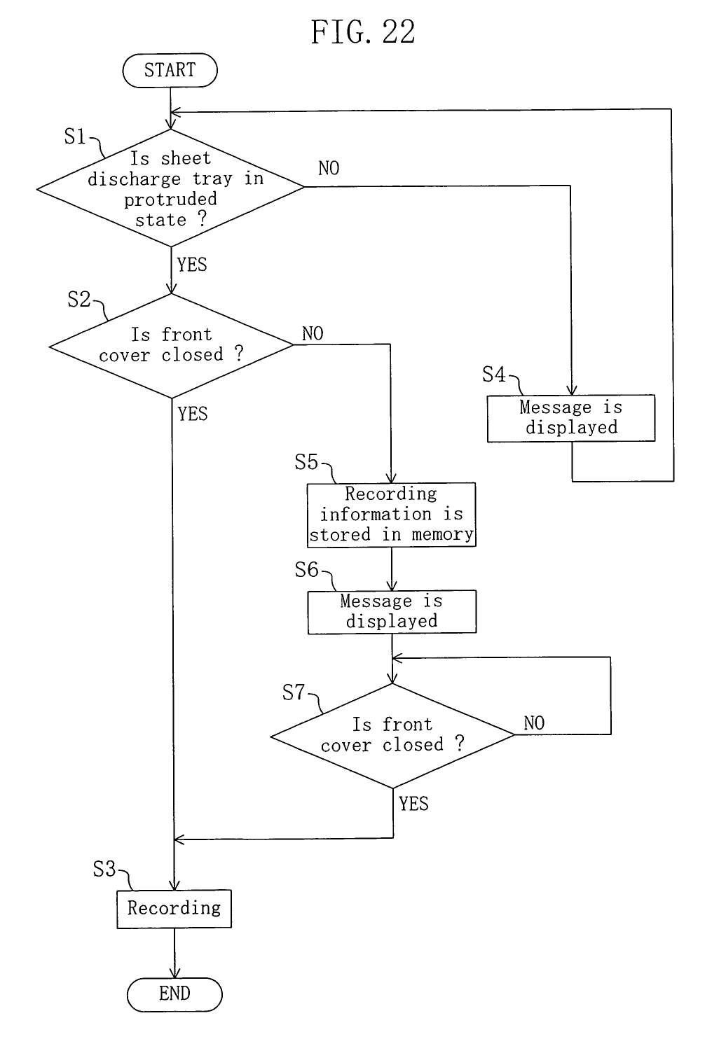

When the recording operation is started, the user operates the operation button 155 or operates a remote controller to designate the recording operation. The designation of the recording operation is input to the main control circuit 310 as a recording operation command. As shown in FIG. 22, the main control circuit 310 which received the recording operation command determines whether the sheet discharge tray 220 is in the protruded state (that is, in the pulled-out state) or not at step S1.

When the sheet discharge tray 220 is in the housed state, the operation proceeds to step S4 and a predetermined message is displayed on the display of the operation panel 50 or the television screen. For example, a massage such as “Sheet discharge tray 220 is not pulled out. Please pull out the sheet discharge tray 220.” is displayed.

When it is determined that the sheet discharge tray 220 is in the protruded state at step S1, the operation proceeds to step S2. It is determined whether the front panel 31 is closed or not at step S2. When the front panel 31 is closed, the recording operation is started at step S3. Meanwhile, when the front panel 31 is opened, the operation proceeds to step S5.

At step S5, the command or information regarding the recording operation is temporally stored in the memory 304 by the main control circuit 310. Then, a predetermined message such as “Front cover is opened, Printing is started after the front cover is closed.” is displayed on the operation panel 50 or the television screen at step S6. In addition, the user may be informed of the message with audio through the speaker of the television 7 instead of the message on the screen on the television 7 or together with that message. Of course, the message may be notified by another audio device. The same is true in the case of the message display at the step S4.

After the massage is displayed at step S6, it is determined whether the front panel 31 is closed or not at step S7. When the front panel 31 is closed, the recording operation is carried out at step S3. In other words, the recording operation is started after the front panel 31 is closed.

When the front panel 31 is opened during the recording operation, the main control circuit 310 continues the recording operation until a carriage 102 is moved to its home position. Thus, when the carriage 102 reaches the home position, the recording operation is interrupted. That is, the carriage 102 stands by at the home position. When the front panel 31 is closed again, the recording operation is started again. In addition, when the front panel 31 is opened, the same message as that at the step S6 may be displayed.

When ink shortage occurs in any ink cartridge 750, the main control circuit 310 displays the fact that the ink shortage occurs on the operation panel 50 or the screen of the television 7. Thus, the user can easily recognize that the ink shortage occurs.

The ink cartridge 50 is exchanged by opening the front panel 31. However, the user cannot see the operation panel 50 while the front panel 31 is opened. Therefore, it is difficult for the user to recognize which of the plural ink cartridges 750 is running out of the ink. Thus, according to the printer 1, when the front panel 31 is opened in a state where ink shortage occurs, a message showing that which of the ink cartridge 750 is running out of the ink is displayed on the screen of the television 7. In addition, the message about the ink shortage can be notified with audio through the speaker of the television 7. In addition, the message may be notified by using another audio device instead of the television 7.

As described above, according to this printer 1, when the recording operation command is input while the front panel 31 is opened, the recording operation is not started immediately and the recording operation is started after the front panel 31 is closed. Therefore, since the carriage 102 does not move reciprocally while the front panel 31 is opened, even when the user inserts the hand into the casing 10, the carriage 102 does not hit the hand.

In addition, if the recording operation is performed in the state where the front panel 31 is opened, the recording sheet is prevented from being discharged by the front panel 31 and the paper jam could happen. However, according to this printer 1, such paper jam can be prevented.

Furthermore, when the front panel 31 is opened to exchange the ink cartridge 750, the recording operation command could be input by mistake. However, according to this printer 1, since the recording operation is not started while the front panel 31 is opened, the recording operation is not performed while the ink cartridge 750 does not exist, so that air is prevented from being inhaled into an ink flow path.

In addition, according to this printer 1, the recording operation command input while the front panel 31 is opened is stored in the memory 304 once, and the recording operation is started after the front panel 31 is closed. Therefore, it is not necessary for the user to input the recording operation command again after the front panel 31 is closed, so that the user can dispense with the inputting operation.

According to this printer 1, since there is provided the rib 251 to prevent the front panel 31 from being opened while the sheet discharge tray 220 in the protruded state, the front panel 31 can be prevented from being opened while the sheet discharge tray 220 is in the pulled-out state. Therefore, the sheet discharge tray 220 and the front panel 31 are prevented from bumping against each other and the device can be prevented from being damaged.

In addition, according to this printer 1, since there is provided the tray-lock rib 272 to prevent the sheet discharge tray 220 from being protruded forward (pulled out forward) while the front panel 31 is opened, the sheet discharge tray 220 is prevented from being pulled out while the front panel 31 is opened. Therefore, the sheet discharge tray 220 and the front panel 31 are prevented from bumping against each other, so that the device can be prevented from being damaged.

According to this printer 1, if the front panel 31 is opened during the recording operation, the recording operation is continued until the carriage 102 returns to its home position, and the recording operation is interrupted after the carriage 102 reaches the home position. Thus, even when the user inserts the hand into the casing, since a time until the carriage 102 reaches the home position is shorter than a time until the user opens the front panel 31 and inserts the hand, the hand of the user and the carriage 102 are prevented from bumping against each other. Meanwhile, unlike the case where the recording operation is interrupted at the same time as the front panel 31 is opened, since the recording operation is continued until the carriage 102 reaches the home position, the recording operation can be smoothly started again.

Since this printer 1 can display the predetermined message appropriately on the screen of the television 7 by connecting to the television 7, the convenience of the printer 1 can be improved. Especially, when the ink cartridge 750 is running out of the ink, since that ink cartridge 750 can be displayed on the screen of the television 7, the user can easily know which ink cartridge 750 is running out of the ink on the screen even while the front panel 31 is opened.

In addition, according to the above embodiments, when the recording operation is designated while the front panel 31 is opened, the designation is stored until the front panel 31 is closed and then the recording operation is performed after the front panel 31 is closed. However, even after the front panel 31 is closed, it is preferable that the recording operation is not started until it is confirmed that the sheet discharge tray 220 is pulled out. Thus, when the recording operation is designated in the state where the front panel 31 is opened, the main control circuit 310 preferably stores the designation in the memory 304 until the front panel 31 is closed and the sheet discharge tray 220 is pulled out forward and starts the recording operation after the front panel 31 is closed and the sheet discharge tray 220 is pulled out.

According to the above embodiments, the locking mechanism which prevents the front panel 31 from being opened while the sheet discharge tray 220 is pulled out is the rib 251 provided in the sheet discharge tray 220 (refer to FIG. 18). However, the locking mechanism is not limited to the rib 251 and another mechanism may be used.

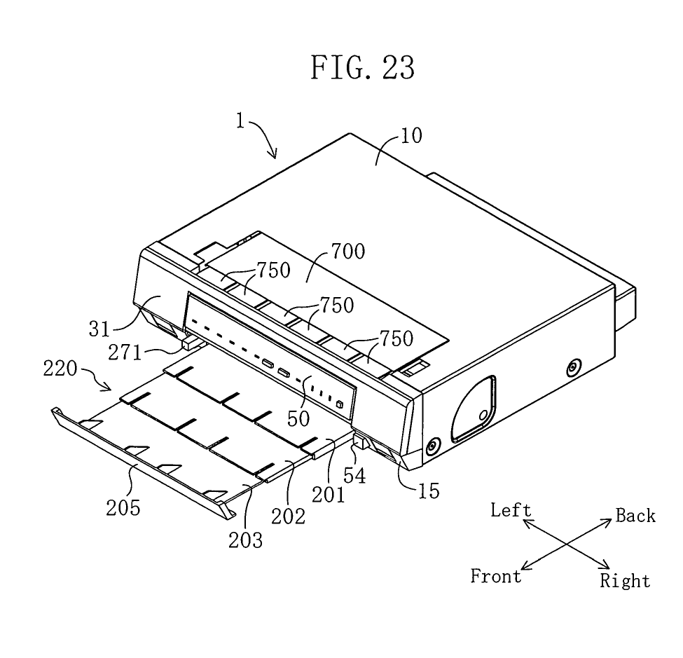

For example, a locking mechanism shown in FIG. 23 may be employed. The locking mechanism shown in FIG. 23 comprises a lock pin 271 which is in a protruded state when the sheet discharge tray 220 is pulled out forward. That is, when the lock pin 271 is withdrawn backward as the sheet discharge tray 220 is withdrawn backward to be housed, and when the sheet discharge tray 220 is withdrawn forward, it is automatically protruded forward. The protruded lock pin 271 comes in contact with the bottom of the front panel 31 and prevents the front panel 31 from being turned. Thus, the front panel 31 is locked.

According to the above embodiments, the sheet discharge tray 220 is prevented from being pulled out when the front panel 31 is opened by the tray-lock rib 272 which is fixed to the back face of the front panel 31 (refer to FIG. 17). However, the locking mechanism for preventing the sheet discharge tray 220 from being pulled out is not limited to the above mechanism.

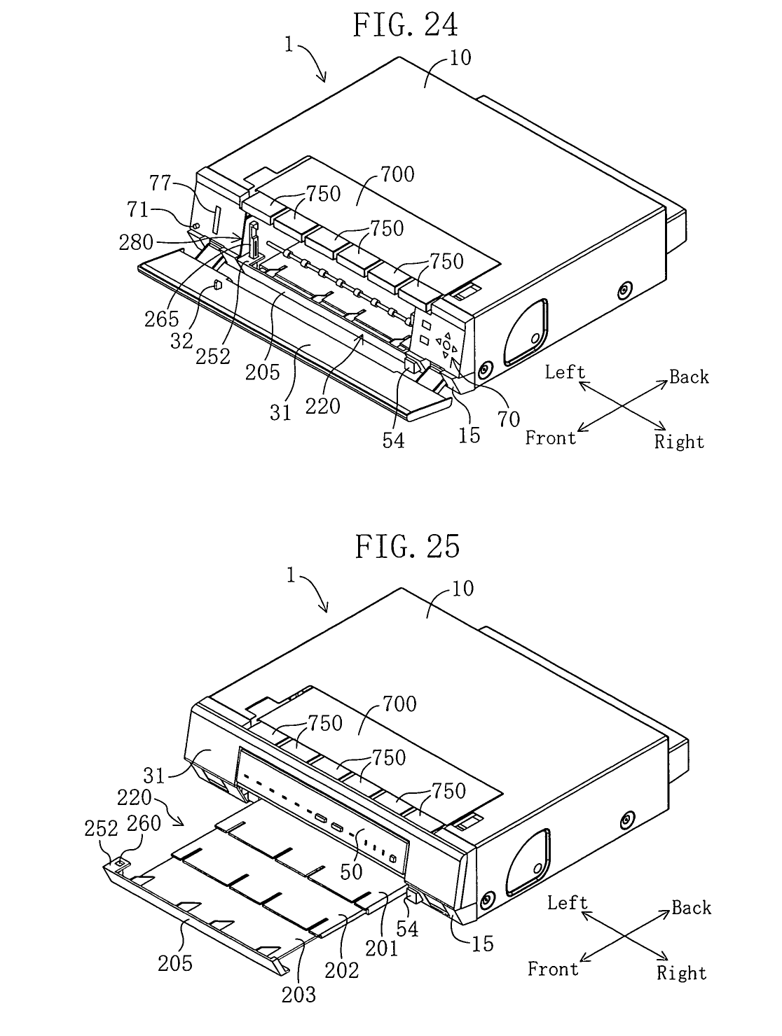

A description will be made of a variation of the locking mechanism for preventing the sheet discharge tray 220 from being pulled out while the front panel 31 is opened with reference to FIGS. 24 to 27. As shown in FIG. 25, according to a locking mechanism 280, a locking chip 252 in which a lock hole 260 is formed is provided at a left end of a handle 205 of a sheet discharge tray 220. As shown in FIG. 24, a lock pin 265 which is inserted in the lock hole 260 when the sheet discharge tray 220 is in a housed state is provided inside a casing 10.

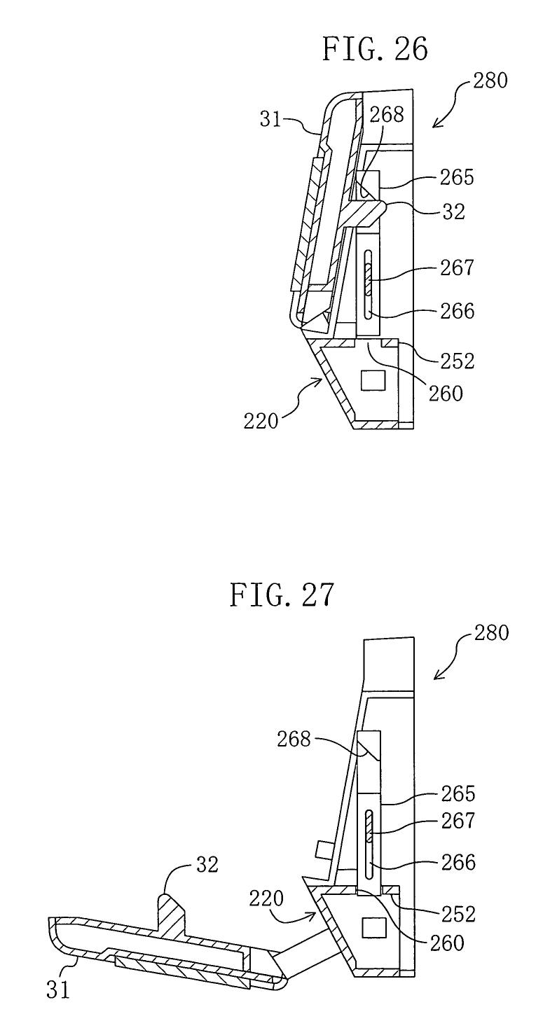

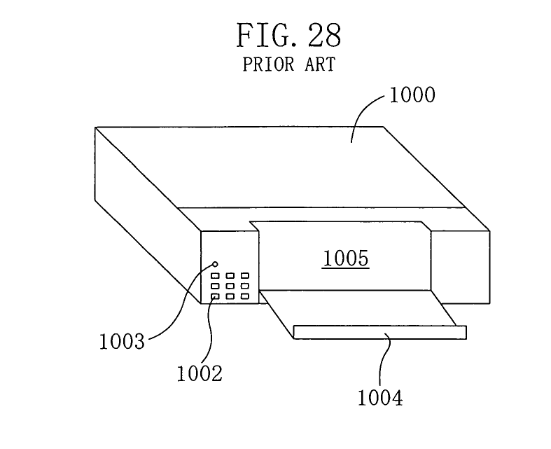

As shown in FIG. 26 in detail, the lock pin 265 comprises a stick-shaped body which is thin and long in the vertical direction. A slit groove 266 which is thin and long in the vertical direction is formed in a middle part of the lock pin 265. A lock pin guide 267 which engages with the slit groove 266 is provided inside the casing 10. Therefore, the lock pin 265 is guided by the lock pin guide 267 while it moves up and down.

An inclined plane 268 which is inclined in the lower back direction (lower right direction in FIG. 26) is formed on the upper side of the lock pin 265. An unlock pin 32 which has a plane slanted in the lower back direction and slides along the inclined plane 268 of the lock pin 265 is provided on the back side of the front panel 31. The lock pin 265 is forced downward by a spring (not shown).

As shown in FIG. 27, when the front panel 31 is opened, the unlock pin 32 leaves from the lock pin 265 and the lock pin 265 is moved downward by spring force. As a result, a lower end of the lock pin 265 is inserted in the lock hole 260 of the locking chip 252 of the sheet discharge tray 220. Thus, the lock pin 265 engages with the lock hole 260 and the sheet discharge tray 220 is prevented from being pulled out by the lock pin 265.

Meanwhile, as shown in FIG. 26, when the front panel 31 is closed, the unlock pin 32 accordingly comes in contact with the inclined plane 268 of the lock pin 265 and pulls the lock pin 265 upward. As a result, the lock pin 265 gets out of the lock hole 260 of the locking chip 252 and the sheet discharge tray 220 is unlocked.

In addition, an embodiment in which the embodiment 1 and the embodiment 2 are appropriately combined can be implemented.

Although the present invention has been described and illustrated in detail, it is clearly understood that the same is by way of illustration and example only and is not to be taken by way of limitation, the spirit and scope of the present invention being limited only by the terms of the appended claims.

1. A recording apparatus comprising:
an almost box-shaped casing having an opening on the front side;
a recording mechanism arranged in the casing, for performing a recording operation on a recording medium; and
a front panel comprising an input and display unit consisting of at least one of an input unit and a display unit on its front face and covering the opening of the casing such that the opening can be opened and closed.

2. The recording apparatus of claim 1, wherein
a length of the front panel in the lateral direction is almost equal to a length of the casing in the lateral direction.

3. The recording apparatus of claim 1, wherein
the input and display unit is arranged on the front panel in the center of the casing in the right-and-left direction.

4. The recording apparatus of claim 1, wherein
a feed opening to which a recording medium before recorded is inserted and a discharge opening from which a recording medium after recorded is discharged are provided in the casing or the front panel, and
the input and display unit is arranged so as to be aligned with the feed opening and the discharge opening in the vertical direction.

5. The recording apparatus of claim 4, wherein
the input and display unit is arranged on the upper side of the feed opening and the discharge opening.

6. The recording apparatus of claim 4, wherein
the input and display unit is arranged between the feed opening and the discharge opening.

7. The recording apparatus of claim 1, wherein
the casing is in the form of almost rectangular solid in which a length in the vertical direction is smaller than lengths in the right-and-left direction and in the back-and-forth direction.

8. The recording apparatus of claim 1, wherein
the input and display unit comprises one or more indication lights, a first display circuit which displays first information on the indication light, a second display circuit which displays second information on the indication light, and a selection unit for selecting the first display circuit or the second display circuit.

9. The recording apparatus of claim 8, wherein
the recording mechanism comprises an inkjet recording head,
the recording apparatus further comprises an ink tank which supplies ink to the recording head, and a detection unit for detecting ink shortage in the ink tank,
the first information is about a kind of the recording medium, and
the second information is about ink shortage.

10. The recording apparatus of claim 1, wherein
the recording mechanism comprises an inkjet recording head and a carriage mechanism for moving the recording head reciprocally, and
the recording apparatus further comprises a cartridge holder arranged on the front side in the casing, an ink cartridge which is detachably mounted on the cartridge holder through the opening of the casing, and an ink supply tube connecting the ink cartridge mounted on the cartridge holder to the recording head.

11. A recording apparatus comprising:
an almost box-shaped casing having an opening on the front side;
a recording mechanism arranged in the casing, for performing a recording operation on a recording medium;
a front cover provided on the front side of the casing and covering the opening of the casing such that the opening can be opened and closed;
a sensor for detecting opened and closed states of the front cover;
a control unit for performing a recording operation by the recording mechanism in response to receipt of a recording operation command, wherein
when the control unit receives the recording operation command which instructs the recording mechanism to perform a recording operation in a state where the front cover is opened, it stores the recording operation command until the front cover is closed based on the detection result of the sensor, and instructs the recording mechanism to perform the recording operation after the front cover is closed.

12. The recording apparatus of claim 11, further comprising:
a discharge tray which is extendable or movable back and forth between a protruded state in which it is protruded forward from the casing and a housed state in which it is housed in the casing; and
an opening prohibiting mechanism for prohibiting the front cover from being opened when the discharge tray is in the protruded state.

13. The recording apparatus of claim 11, further comprising:
a discharge tray which is extendable or movable back and forth between a protruded state in which it is protruded forward from the casing and a housed state in which it is housed in the casing; and
a tray protrusion prohibiting mechanism for prohibiting the discharge tray from being moved from the housed state to the protruded state while the front cover is opened.

14. The recording apparatus of claim 11, further comprising:
a discharge tray which is extendable or movable back and forth between a protruded state in which it is protruded forward from the casing and a housed state in which it is housed in the casing; and
a tray sensor for detecting whether the discharge tray is in the protruded state or the housed state, wherein
when the control unit receives the recording operation command while the front cover is opened, even after the front cover is closed, it does not perform a recording operation while the discharge tray is in the housed state, and performs the recording operation when the discharge tray is in the protruded state, based on the detection result of the tray sensor.

15. The recording apparatus of claim 11, wherein
the recording mechanism comprises a carriage axis extending in the casing in the right-and-left direction, a carriage moving along the carriage axis reciprocally in the right-and-left direction, and a recording head mounted on the carriage,
one or both ends of the carriage axis are home positions in which the carriage stands by while recording is not performed, and
the control unit continues the recording operation until the carriage reaches the home position, and stops the recording operation when the carriage reaches the home position when the front cover is opened during the recording operation by the recording mechanism.

16. The recording apparatus of claim 11, further comprising a signal output circuit for transmitting a signal by wired or wireless connection to an image display unit or an audio output unit, wherein
when the front cover is opened, the control unit transmits the signal to the image display unit or the audio output unit through the signal output circuit to direct the image display unit or the audio output unit to display or output predetermined information.

17. The recording apparatus of claim 16, wherein
when the control unit receives the recording operation command in a state where the front cover is opened, it directs the image display unit or the audio output unit to display or output information that the recording operation is started after the front cover is closed.

18. The recording apparatus of claim 16, further comprising:
a cartridge holder arranged in the casing, for holding two or more ink cartridges; and
an ink-shortage sensor for detecting ink shortage of each ink cartridge, wherein
when the front cover is opened in a state where the ink shortage occurs in a certain ink cartridge, the control unit directs the image display unit or the audio output unit to display or output information that which ink cartridge is running out of ink.

19. A recording apparatus comprising:
an almost box-shaped casing having an opening at the front;
a recording mechanism arranged in the casing, for performing a recording operation on a recording medium;
a front cover provided on the front side of the casing and covering at least the opening such that the opening can be opened and closed;
a discharge tray which is extendable or movable back and forth between a protruded state in which it is protruded forward from the casing and a housed state in which it is housed in the casing; and
an opening prohibiting mechanism for prohibiting the front cover from being opened when the discharge tray is in the protruded state.

20. The recording apparatus of claim 19, wherein
the opening prohibiting mechanism comprises a rib which is protruded upward from the discharge tray when the discharge tray is in the protruded state, and prevents the front cover from being opened by coming into contact with the front cover.

21. The recording apparatus of claim 19, wherein
the opening prohibiting mechanism comprises a lock pin which is housed in the casing when the discharge tray is in the housed state, protruded forward from the casing when the discharge tray is in the protruded state, and prevents the front cover from being opened by coming into contact with the front cover in the protruded state.

22. A recording apparatus comprising:
an almost box-shaped casing having an opening at the front;
a recording mechanism arranged in the casing, for performing a recording operation on a recording medium;
a front cover provided on the front side of the casing and covering at least the opening such that the opening can be opened and closed;
a discharge tray which is extendable or movable back and forth between a protruded state in which it is protruded forward from the casing and a housed state in which it is housed in the casing; and
a tray protrusion prohibiting mechanism for prohibiting the discharge tray from being moved from the housed state to the protruded state when the front cover is opened.

23. The recording apparatus of claim 22, wherein
the tray protrusion prohibiting mechanism comprises a rib which is protruded upward or backward from the back face of the front cover when the front cover is in the opened state, and prevents the discharge tray from being protruded forward by coming into contact with the discharge tray.

24. The recording apparatus of claim 22, wherein
the tray protrusion prohibiting mechanism comprises a locking mechanism which prevents the discharge tray from being extended or moved by engaging with the discharge tray when the front cover is opened, and unlocks the engagement with the discharge tray when the front cover is closed.
